(19) United States
(12) Patent Application Publication
(10) Pub. No.: US 2019/0216277 A1
(43) Pub. Date: Jul. 18, 2019

(54) Upright vacuum with telescoping head

(71) Applicant: Intelliclean Solutions, LLC, St. Petersburg, FL (US)

(72) Inventors: Larry York, St. Petersburg, FL (US); Randy Spencer, St. Petersburg, FL (US)

(21) Appl. No.: 15/871,166

(22) Filed: Jan. 15, 2018

(51) Int. Cl. A47L 5/22; A47L 5/28; A47L 9/00; A47L 9/18; B01D 47/02

(52) U.S. Cl. CPC A47L 5/225; A47L 5/28; B01D 47/02; A47L 9/181; A47L 9/0027

(57) ABSTRACT

The disclosed upright vacuum with telescoping head permits vacuuming beneath furniture and other home obstacles. The head of the vacuum extends from the body, allowing the slimmer head to slide beneath furniture without the bulkier body.

The head of the vacuum extends from the body using an extending section formed from two or more nested, telescoping suction tubes. The tubes are sealed to one-another using one or more gaskets. The telescoping tubes channel incoming air from the power head to the housing, where it is routed through a filtration mechanism.

### CROSS-REFERENCE TO RELATED APPLICATION

This application is a continuation-in-part of pending U.S. patent application Ser. No. 15/133,146, filed Apr. 19, 2016, which in turn is a continuation-in-part of issued U.S. Pat. No. 9,782,049, issued Oct. 10, 2017, which in turn claimed the benefit of U.S. Provisional Application No. 62/122,300, filed Oct. 16, 2014.

### FIELD

The present disclosure pertains to the field of vacuum cleaners and more particularly to vacuum with a telescoping head.

### BACKGROUND

Vacuum cleaners are commonly divided into canister vacuums and upright vacuums.

Canister vacuum cleaners have a relatively stationary canister that is connected to a movable wand by a flexible connecting hose.

Upright vacuum cleaners are integrated units having an inlet, a filter, bag and/or canister, and a handle, with all components connected vertically in a single, portable unit.

Upright-style vacuum cleaners provide greater versatility and convenience than canister type vacuum cleaners because the upright-style vacuum cleaner is an integrated unit that can be moved and maneuvered using a single handle.

While uprights are a favored vacuum style, their integrated design makes vacuuming beneath furniture challenging. This difficulty is due to the head being in close proximity to the body, which is made bulky by integration of many components.

What is needed is a vacuum cleaner with the compact features of an upright, but the ability to reach under furniture.

### SUMMARY

The disclosed upright vacuum with telescoping head permits vacuuming beneath furniture and other home obstacles. The head of the vacuum extends from the body, allowing the slimmer head to slide beneath furniture without the bulkier body in the way.

The head of the vacuum is able to move away from, and toward, the body using an extending section formed from two or more nested, telescoping suction tubes. The tubes are sealed to one-another using one or more gaskets. The telescoping tubes channel incoming air from the power head to the housing, where the air is routed through a filtration mechanism.

The preferred filtration mechanism is the water filtration system described herein. But more traditional mechanisms are also acceptable, such as disposable bags, reusable bags, cloth filters, paper filters, a cyclone separator, and so forth.

In alternative embodiments, the telescoping suction tube is replaced with a suction tube that stretches in length. For example, a PVC helix suction hose, or other such corrugated or metal/plastic reinforced hose. In such applications alternative means of structurally supporting the housing are likely necessary because the suction tube no longer provides structural support.

Embodiments of the upright vacuums that include an electrically-powered head further require a power cord parallel to the suction tube. The preferred embodiment uses a coiled electrical cable that is partially protected by a conduit. Optionally included is an accordion sleeve between the coiled cable and the conduit, helping the cable to slide in and out of the conduit.

Given that the housing, also referred to as the body, of the vacuum moves up and down, a mechanism is required to maintain the position of the housing at its chosen elevation. The preferred mechanism is a movable latch that interacts with two rollers. The rollers are held captive by a collar that surrounds the telescoping vacuum tube. The collar is placed at the end of the outer telescoping tube, which remains in a fixed position with respect to the housing.

The action of the captive rollers locking with the notches results in indexed positions, or a heights that lock at specific positions.

When the rollers are in position, the load of the body is transferred as follows: From the body, to the brackets that surround the outer telescoping tube, to the outer telescoping tube, to the collar, to the captive rollers, to the notches in the inner telescoping tube, to the telescoping tube, and finally to the power head connection.

The latch does not carry a load, but instead acts to either allow the rollers to slide out of the notches of the inner telescoping tube or to keep the rollers fixed within the notches of the inner telescoping tube.

### BRIEF DESCRIPTION OF THE DRAWINGS

The invention can be best understood by those having ordinary skill in the art by reference to the following detailed description when considered in conjunction with the accompanying drawings in which:

FIG. 1 is a front view of an example vacuum cleaner;

FIG. 2 is a perspective view of the vacuum cleaner of FIG. 1;

FIG. 3 is a rear elevation view of the vacuum cleaner of FIG. 1;

FIG. 4 is a side view of the vacuum cleaner of FIG. 1;

FIG. 5 is an additional front view of the vacuum cleaner of FIG. 1;

FIG. 6 is a detailed side view of an exemplary water tank intake of the vacuum cleaner of FIG. 1;

FIG. 7 is a side view of an example sealing flap and movement resistor positioned within the vacuum cleaner of FIG. 1;

FIG. 8 is a front view of an example sealing flap and movement resistor for a vacuum

FIG. 9 is a is a side view of the sealing flap and movement resistor of FIG. 8;

FIG. 10 is a view of an example water tank detached from the housing of the vacuum cleaner of FIG. 1;

FIG. 11 is a view of an example motor of the vacuum cleaner of FIG. 1;

FIG. 12 is a detailed view of the motor of FIG. 11;

FIG. 13 shows the separator;

FIG. 14 shows the retractable extension cord;

FIG. 15 shows a side view of a vacuum cleaner that can operate as a wet vacuum;

FIG. 16 shows an isometric view of a vacuum cleaner with an extendable head, the vacuum cleaner shown in its lowered position;

FIG. 17 shows an isometric view of a vacuum cleaner with an extendable head, the vacuum cleaner shown in its raised position;

FIG. 18 shows a view of the extension mechanism within the vacuum cleaner that permits the head to move toward and away from the housing;

FIG. 19 shows the telescoping tube that interacts with a latching mechanism to hold the vacuum in a chosen position, the tube shown in its lowered or retracted position;

FIG. 20 shows the telescoping tube that interacts with a latching mechanism to hold the vacuum in a chosen position, the tube shown in its raised or extended position;

FIG. 21 shows the collar that forms the basis for the locking mechanism that holds the extending tube in place;

FIG. 22 shows the latch that acts to engage and disengage the rollers against the telescoping tube; and

FIG. 23 shows a rear view of the latch interacting with the notches of the telescoping tube, the collar hidden from view.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

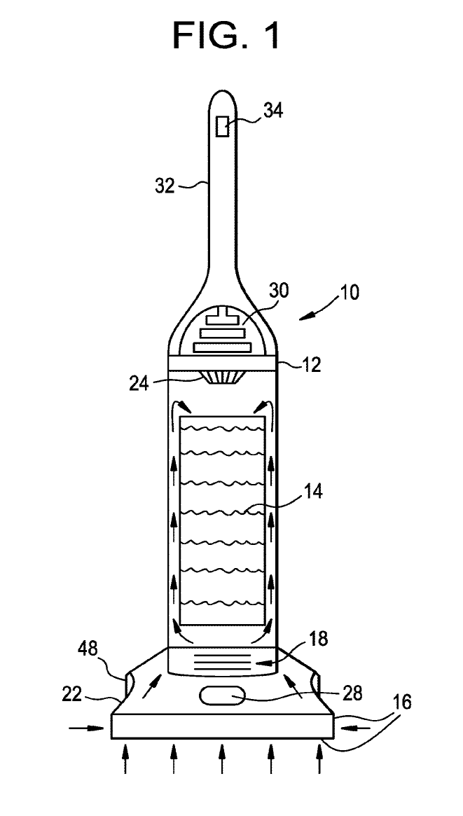

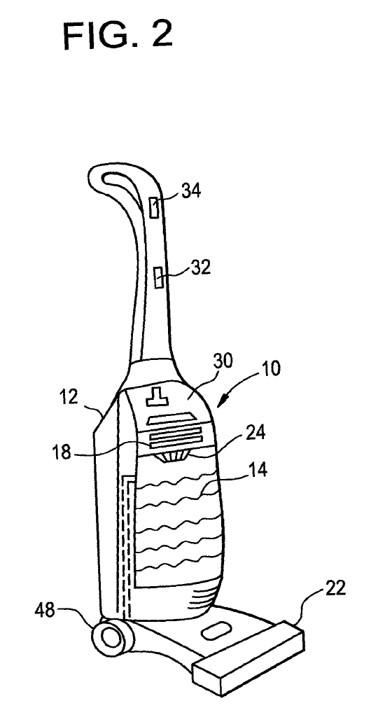

Examples of the present disclosure are best understood by referring to FIGS. 1-23 of the drawings, like numerals being used for like and corresponding parts of the various drawings

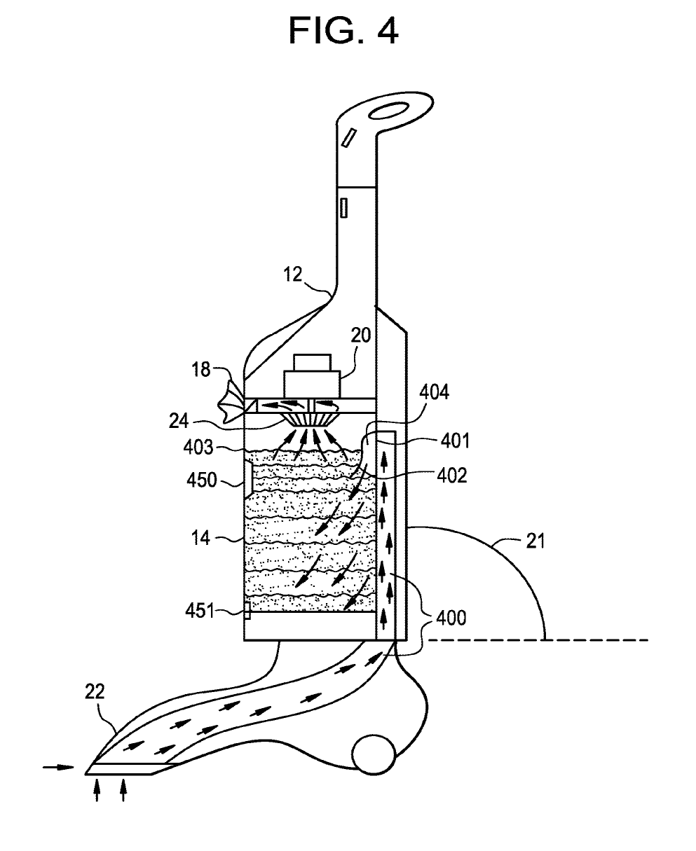

Referring now to the figures and particularly to FIG. 1, there is shown an exemplary upright vacuum cleaner 10 having housing 12. Removably contained within housing 12 is water tank or filtration liquid tank 14. In an exemplary embodiment, the water tank 14 is easily removable from housing 12 to enable the convenient removal and replacement of liquid therein. The water tank 14 may have any shape and/or size. Motor 20 (FIG. 4) is positioned within (or otherwise supported by) the housing 12.

The water tank 14 may include liquid (such as water) that contacts the air flow into the vacuum cleaner 10 and removes debris. The vacuum cleaner 10 directs incoming air and debris into contact with the liquid, which is typically water that absorbs the debris. Air flow through the water tank 14 also causes the liquid to circulate or agitate, which increases the efficiency of the absorption. The use of liquid as a filter (as opposed to a dry, mechanical filter) has a significant advantage in that the vacuum cleaner 10 uses readily available water, thereby eliminating the need for replaceable filters. In addition, the liquid in the water tank 10 may provide a room humidifying effect since some of the water may become vaporized in the air discharged from the vacuum cleaner 10 during use.

Air is discharged out exhaust port 18.

Further shown is vacuum cleaner handle 32 that may telescope up and down, and compartment 30 for storing attachments typically used with vacuum cleaners. Vacuum nozzle head 22 contains a brushing unit (not shown in FIG. 1) typically contained in vacuum cleaners for brushing carpet free of debris, and may further include a rubber squeegee. Suction and airflow motor 28 is supported in vacuum nozzle head in standard fashion. Suction and airflow motor 28 may rotate the brushing unit, causing the vacuum nozzle head 22 to be a power nozzle. Wheels 48 are located on the four comers of vacuum nozzle head 22 providing smooth rolling support of vacuum cleaner 10. In other embodiments, other wheel and support arrangements may be used.

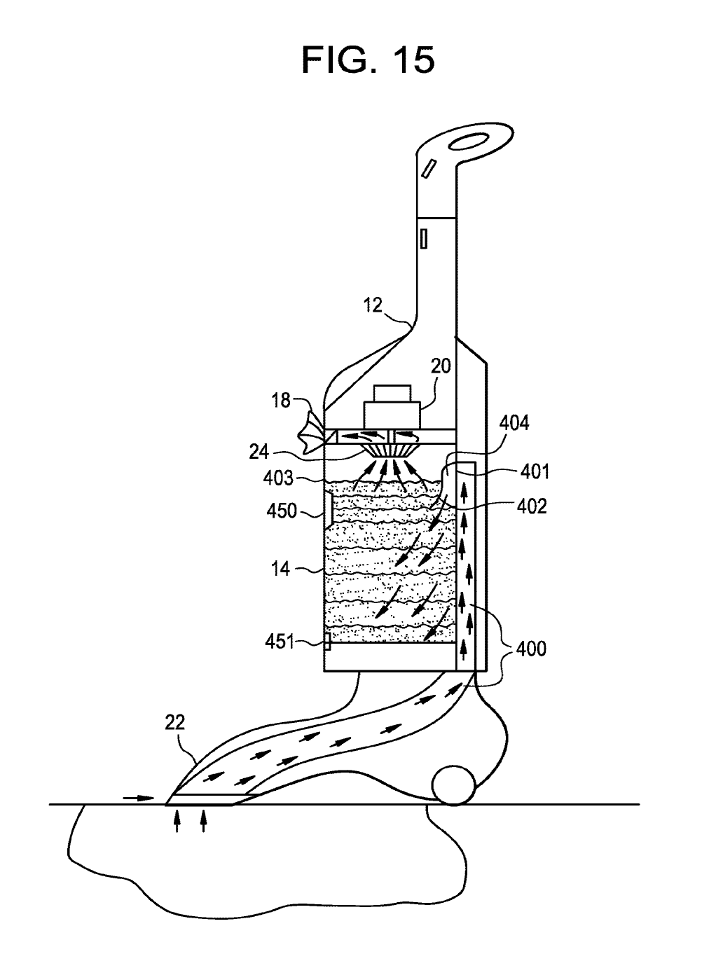

In operation, switch 34 initializes motor 20 of vacuum cleaner 10 creating an airflow and suction force, or vacuum, to draw air (shown by arrows) entrained with debris. The debris can be any non-liquid matter, such as dust, dirt, particulates, microbes, and/or contaminants, or as is seen in FIG. 15, liquid matter. The air entrained with debris is drawn in through the vacuum nozzle head 22 and the inlet ports 16 and into contact with the liquid filter water tank 14. Motor 20 contained within housing 12 operates separator 24, rotating the separator 24 to speeds up to 16,000 rpm, forcing the debris to mix with water in water tank 14. By mixing the debris with the water, the debris is absorbed into the water and is prevented from being exhausted from the water tank 14. Additionally, separator 24 may draw and separate the clean exhaust air from the heavier water and particulates. The liquid filter water tank 14 may utilize one or more known liquid agents with filtration qualities, but contains water in an exemplary embodiment.

The housing 12 may be moveably coupled to the vacuum nozzle head 22. For example, the housing 12 may be tilted (or otherwise moved) with respect to the vacuum nozzle head 22. As is illustrated in FIG. 4, the housing 12 may be titled backwards from an upright position with respect to the vacuum nozzle head 22 by a tilting angle 21. Tilting angle 21 may be any angle. The housing 12 may be tilted with respect to the vacuum nozzle head 22. Thus, even when the housing 12 is tilted, the vacuum nozzle head 22 may remain in the same upright position (shown in FIG. 4).

Tilting of the housing 12 may be accomplished by pressing a button or lever positioned on the housing 12 or the vacuum nozzle head 22, or the housing 12 may tilt freely with respect to the vacuum nozzle head 22. This button or lever may release the housing 12, allowing housing 12 to be tilted. When the housing 12 is tilted, all of the components of the housing 12 (including the water tank 14) may be titled at the same (or substantially the same) angle as the housing 12.

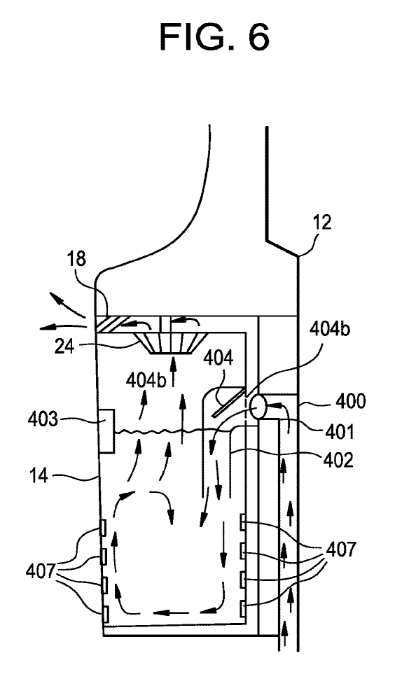

Water tank 14 can be a liquid reservoir or basin made of plastic or other materials and molded using known techniques. Liquid or dry micro silver, or nano silver, may be used as an antimicrobial component in the exemplary embodiment, although any suitable microbial agent may be used. The micro or nano silver can be included into the plastic mold during processing. Any amount of micro or nano silver may be poured into the plastic mold. For example, the micro silver (or any other antimicrobial particle) may make up 1%-6% of the plastic mold. In some examples, the micro silver may make up 5% of the plastic mold. In some examples, this percentage of micro silver may allow the water tank 14 to achieve approximately 100% efficiency for killing contaminants in the water tank 14. Antimicrobial particles 407, such as nano-silver, are shown in FIG. 6, in the wall of the water tank 14 during operation of the vacuum cleaner 10. As shown in FIG. 6, antimicrobial particles 407 are embedded into the water tank interior wall and the circulation of water (shown by arrows), including contaminants, bring the contaminants into contact with the antimicrobial particles 407 to kill them.

Antimicrobial particles may be nano particles, e.g., nano metal ions, oxides, and salts placed in the liquid bath, air flow stream, and/or embedded in the airflow pathway/componentry. Antimicrobial particles may also be micro particles, e.g., micro metal ions, oxides, and salts. Micro particles may be particles with a size within 0.1-100 μm, 0.3-300 μm, 0.7-700 μm, or any combination of the preceding. In particular examples, the micro particles may have a size of 200 μm (or approximately 200 μm, such as 200 μm+/−100 μm).

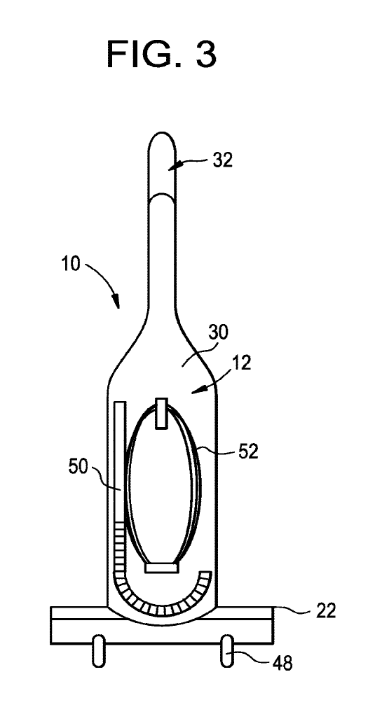

The exemplary embodiment shown in FIG. 3 includes a hose 50 for cleaning with attachments in areas where the power nozzle head 22 cannot accommodate. For suction and airflow, the hose 50 may connect with, for example, intake 400 (discussed below). Further shown is power cord 52 utilized to provide power to the vacuum cleaner 10 wrapped in typical fashion around stays.

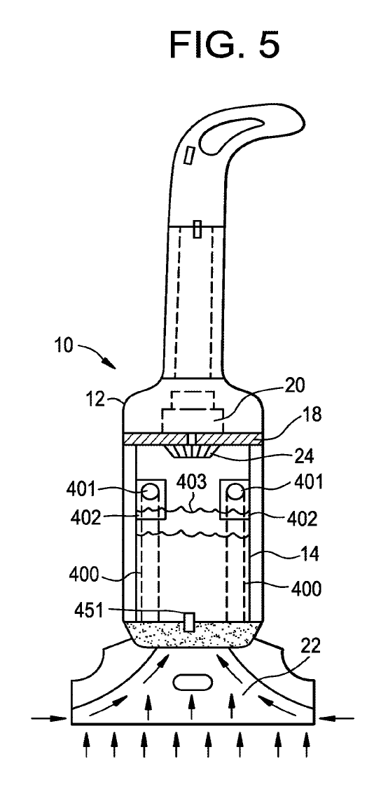

FIGS. 4 and 5 are respectively a side view and a front view of an exemplary embodiment of the water filtration vacuum cleaner 10. As shown in FIG. 4, water tank 14 is inserted into housing 12 between vacuum nozzle head 22 and motor 20. Handle 450 assists a user with inserting water tank 14 into, and removing it from housing 12. When water tank 14 is inserted into housing 12, latch 451 secures water tank 14 therein.

Motor 20 is located in the housing 12 above the water tank 14, and a separator 24 is attached to the bottom of motor 20. Separator 24 may be any device that, when operating, may generate an airflow, and that may further prevent liquid in the water tank 14 from being exhausted out of the water tank 14 through the separator 24. In some examples, separator 24 may separate air from the liquid. For example, separator 24 may draw and separate the clean exhaust air from the heavier water and particulates. This may allow the separator to prevent liquid in the water tank 14 from being exhausted out of the water tank 14 through the separator 24. Separator 24 may also force dirt and debris to mix with liquid in water tank 14.

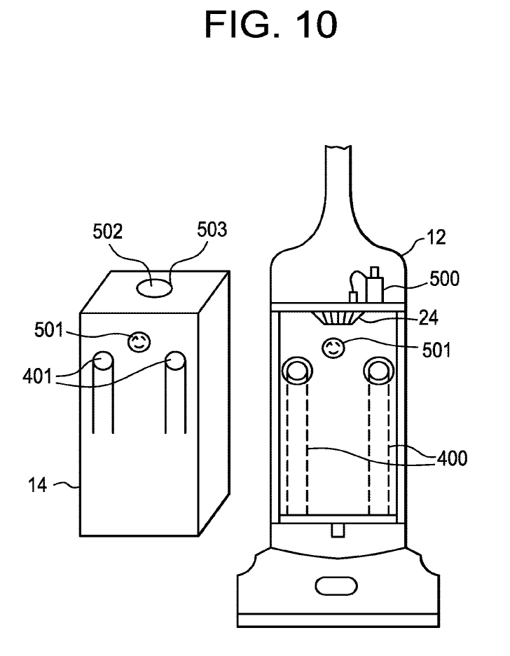

When the water tank 14 is in place within the housing 12, separator 24 protrudes through an opening 502 (FIG. 10) on the top of water tank 14. During operation of the vacuum cleaner 10, separator 24 is rotated by the motor at high speeds, for example and without limitation, approximately 16,000 rpm, to create airflow through the vacuum cleaner 10. The motor 20 and separator 24 generates an airflow speed (or intake velocity) of 90-130 miles per hour in each of the intakes 400 of the vacuum cleaner 10. Air is drawn from outside the housing 12 up intake 400 on either side of the housing 12, through the water tank 14, into the separator 24, and out exhaust ports 18. Exhaust ports 18 may have any size and/or shape. Furthermore, exhaust ports 18 may be positioned at any location on the housing 12 so as to allow air to be exhausted from vacuum cleaner 10. For example, exhaust ports 18 may be positioned on a front side of the housing 12, on one or more sides of the housing 12, on the back of the housing 12, or any combination of the preceding. In some examples, exhaust ports 18 may surround all or a portion of the housing 12.

Intake 400 forms an airflow path from the vacuum nozzle head 22 to inlet port 40I on water tank 14. Inlet port 401 forms an airflow path to the interior of water tank 14. Inlet 401 and intake 400 may collectively form an intake passageway that extends from the tank intake channel 402 to an opening in the vacuum nozzle head 22, such as the opening created by inlet ports 16 in the vacuum nozzle head 22.

Inlet port 401 is above the water level 403 inside water tank 14 to prevent water from entering inlet port 401 and intake tube 400 during operation. Air exhausted from intake 400 passes through inlet port 401 and into tank intake channel 402, which directs the air into the water beneath the water level 403. The tank intake channel 402 may extend under the water level 403 by any distance. This may increase the saturation of the air directed into the water.

In the front view of FIG. 5, intakes 400 are drawn in dashed lines to indicate that they are positioned behind water tank 14. Similarly, tank intake channel 402 is shown transparent to depict inlet port 401. Vacuum cleaner 10 may include any number of intakes 400 (and inlet ports 401 and tank intake channels 402. Additionally, the intakes 400 and inlet ports 401 may be positioned in any location with regard to the water tank 14.

The flow path of the air is further detailed in FIG. 6, with a detailed view of air traveling up intake 400, into inlet port 401, past sealing flap 404 (described below), and down through tank intake channel 402 into water below water level 403 where debris can be immediately trapped and absorbed by the water. FIG. 6 shows a random flow path of air through the swirling water. In operation, forcing the airflow that contains debris below the surface of water level 403 can ensure that the debris will mix with the water and become trapped or absorbed in the water, which filters the debris from the airflow, before the airflow is exhausted from the vacuum.

Another benefit of the current exemplary embodiment of the vacuum cleaner 10 is that it will resist (or prevent) spills and leaks. For example, the vacuum cleaner 10 optionally seals the intakes 400, inlet ports 401, and/or tank intake channels 402 when the vacuum cleaner is deactivated (such as when the separator 24 is not generating airflow). This prevents liquid in the water tank 14 from leaking out of the water tank 14 through the intakes 400, inlet ports 401, and/or tank intake channels 402. Additionally, the vacuum cleaner 10 unseals the intakes 400, inlet ports 401, and/or tank intake channels 402 when the vacuum cleaner is activated (such as when the separator 24 is generating airflow).

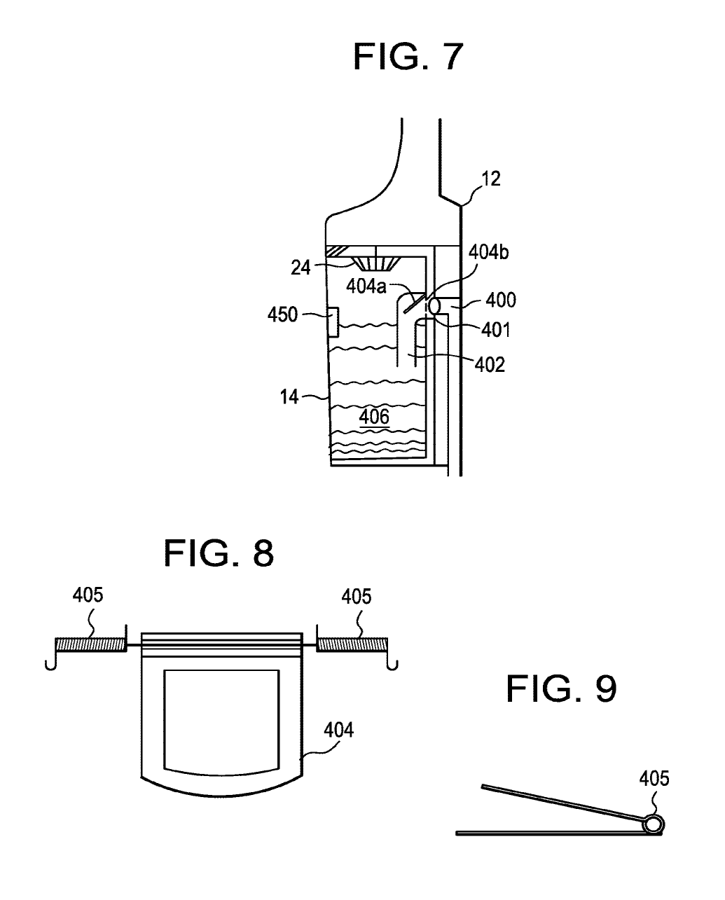

In one example, vacuum cleaner 10 may seal and unseal the intakes 400, inlet ports 401, and/or tank intake channels 402 using sealing flaps 404 shown in FIGS. 4-7. With reference now to FIGS. 4-7, water tank 14 includes sealing flap 404 for closing inlet port 401 within the air intake passages to prevent leaks when the vacuum cleaner 10 is not operating. When the vacuum cleaner 10 is operating (or activated), the air flow from intake 400 to tank intake channel 402 (and/or an automated flap mover 500, discussed below) forces sealing flap 404 open, allowing air to pass through and down into the liquid in water tank 14 via tank intake channel 402. FIG. 7 shows the sealing flap 404 in open 404a and closed 404b (dashed line) configurations. When the vacuum cleaner 10 is not operating (or deactivated), i.e., there is no airflow through intake 400, sealing flap 404 is forced to the closed configuration 404b by a flap movement resistor 405 (such as one or more springs) shown in FIGS. 8 and 9 (and/or the automated flap mover 500 shown in FIG. 10). When the vacuum cleaner 10 is operating and there is airflow through intake tube 400 and inlet port 401, the force of the airflow (and/or the force of the flap movement resistor 500) may overcome the strength (or force) of the flap movement resistor 405 and urges the sealing flap 404 to the open position 404a as depicted in FIGS. 4 and 6.

By closing, and remaining closed, when the vacuum cleaner 10 is not operating, the sealing flap 404 prevents liquid from leaking out of intake 400, thereby resisting spills and leaks of the liquid. The closed sealing flap 404 prevents such leaks even when the vacuum cleaner 10 is tipped or tilted.

In the exemplary embodiment shown by FIGS. 7-9, sealing flap 404 is made from rubber and is generally U-shaped with two flap movement resistors 405 (such as springs) attached to the top of the ‘U’. The flap movement resistors 405 are also attached to the wall of the water tank 14 proximate inlet port 401.

A flap movement resistor 405 may be any device and/or structure that may resist movement of the sealing flap 404 from a closed position (404b) to an open position (404a). By doing so, the flap movement resistor 405 may urge the sealing flap 404 towards the inlet port 401 (e.g., it may urge the sealing flap 405 to a closed position).

In the absence of an opposing force, the flap movement resistor(s) 405 causes the sealing flap 404 to seal against inlet port 401 and/or intake tube 400 as shown in the closed configuration 404b of FIG. 5. Thus, when the vacuum cleaner 10 is not in operation, sealing flap 404 prevents water from leaking out of the water tank 14 through the inlet port 401 and/or intake 400 even if the vacuum cleaner 10 is tipped or tilted.

FIG. 10 shows another example of a sealing flap 404 assembly. As shown in FIG. 10, an automated flap mover 500 is provided in housing 12 and is electrically connected to socket 501 on housing. When water tank 14 is inserted into housing 12, sockets 501 connect, thereby providing a pathway to provide power to the automated flap mover 500. When switch 34 is activated, thus turning on motor 20 and causing separator 24 to generate airflow, power is provided to the automated flap mover 500. This causes the automated flap mover 500 to move the sealing flap 404 from the closed position 404b to the open position 404a. Additionally, when the switch 34 is deactivated (or the vacuum cleaner 10 loses power, such as if the power plug is pulled from an electrical outlet), the automated flap mover 500 moves the sealing flap 404 from the open position 404a to the closed position 404b. The automated flap mover 500 will keep the sealing flap 404 in the closed position 404b until the switch 34 is once again activated (or the motor 20 and separator 24 are otherwise turned on). This prevents liquid from leaking out of intakes 400 even if the vacuum cleaner 10 is tipped or tilted.

Automated flap mover 500 may be any device and/or structure that moves sealing flap 404. For example, automated flap mover 500 may be a solenoid, a solenoid valve, a motorized lever, any other mechanical device for causing movement, any other electro/mechanical device for causing movement, any other device and/or structure for causing automated movement, or any combination of the preceding.

As previously indicated, FIG. 10 further depicts opening 502 on top of water tank 14. Opening 502 is used to empty and fill water tank 14, but is also configured to accept separator 24 when the water tank 14 is inserted into housing 12. Water tank opening 502 includes a raised lip 503 in an exemplary embodiment for sealing against a motor gasket 25 as will be explained with respect to FIGS. 9-11. In other embodiments, opening 502 may be sealed in any other manner suitable for creating a water-tight seal, such as frictional engagements, slotted grooves, a-rings, etc. In general, the centrifugal force generated by separator 24 while vacuum cleaner 10 is in operation is sufficient to deflect any water away from the motor 20 assembly seal.

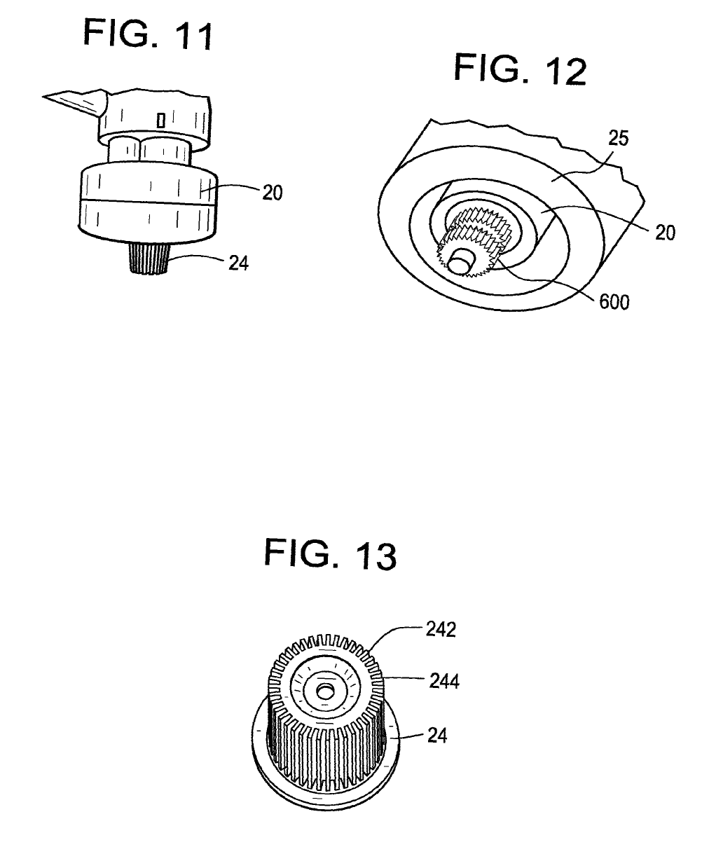

FIGS. 11-13 show additional details regarding the coupling between the motor 20 and the separator 24. As shown in FIG. 11, separator 24 extends away from a bottom of motor 20. Separator 24 is shown in FIG. 13. The ribs 242 and grooves 244 of separator 24 (FIG. 13) create the required airflow for the vacuum cleaner 10 during operation when the separator is rotating. FIG. 12 shows the bottom of motor 20 including gears 600 and gasket 25. During operation, separator 24 is connected to gears 600 such that motor 20 rotates separator 24.

Lip 503 around opening 502 (as illustrated in FIG. 10) on the top of water tank 14 is configured to engage the motor gasket 25 and seal the water tank 14 to the motor 20 when the water tank 14 is inserted in housing 12.

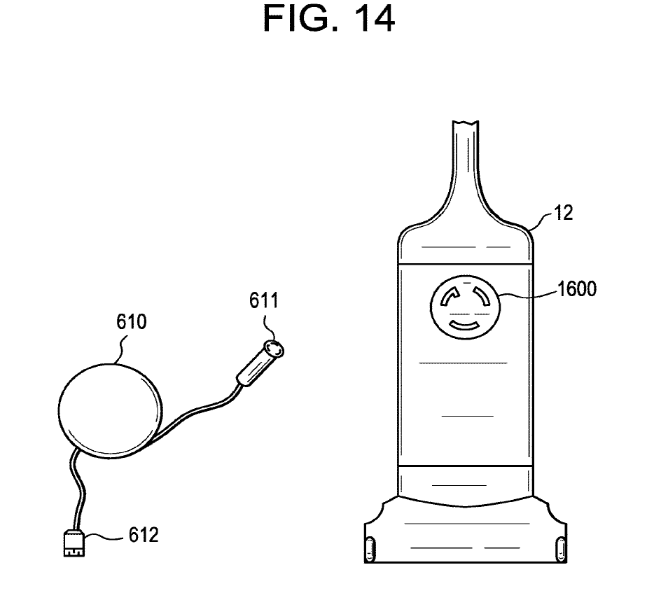

FIG. 14 shows an exemplary removable power connection for the vacuum cleaner 10. The back of housing 12 includes a circular connector 1600 in an exemplary embodiment that mates with a female circular connector 611 on a retractable power cord organizer 610. On an opposite end is a wall outlet 612 (such as a standard 120V wall outlet), which may be unplugged or left plugged in when a user is finished using the vacuum cleaner 10. Retractable power cord organizer 610 is removable from the housing 12, and reattached as discussed above. Any other power connection may be used with the vacuum cleaner 10.

FIG. 15 shows a side view of a vacuum cleaner that can operate as a wet vacuum. As is illustrated, the vacuum cleaner 10 is an upright-style vacuum that can operate as a wet vacuum. When the vacuum cleaner 10 is operating, the vacuum nozzle head 22 (or the hose of the vacuum cleaner 10) may be positioned over liquid (such as water) or a combination of liquid and a dry debris or dirt. The airflow and suction created by the motor 20 and separator 24 may then perform liquid extraction (or water extraction) by drawing the liquid (or liquid and dry debris or dirt) into intake 400. As is illustrated in FIG. 15, the extracted liquid may travel up intake 400, into inlet port 401, past sealing flap 404 (described above), and down through tank intake channel 402 into water tank 14, such as into water below water level 403 in water tank 14. Separator 24 may draw and separate the clean exhaust air from the extracted liquid and any dry debris or dirt. While the clear exhaust air may pass through the separator 24, the extracted liquid may remain in water tank 14. This prevents the extracted liquid from causing damage to one or more components of the vacuum cleaner 10, and thereby allow the vacuum cleaner 10 to operate as a wet vacuum.

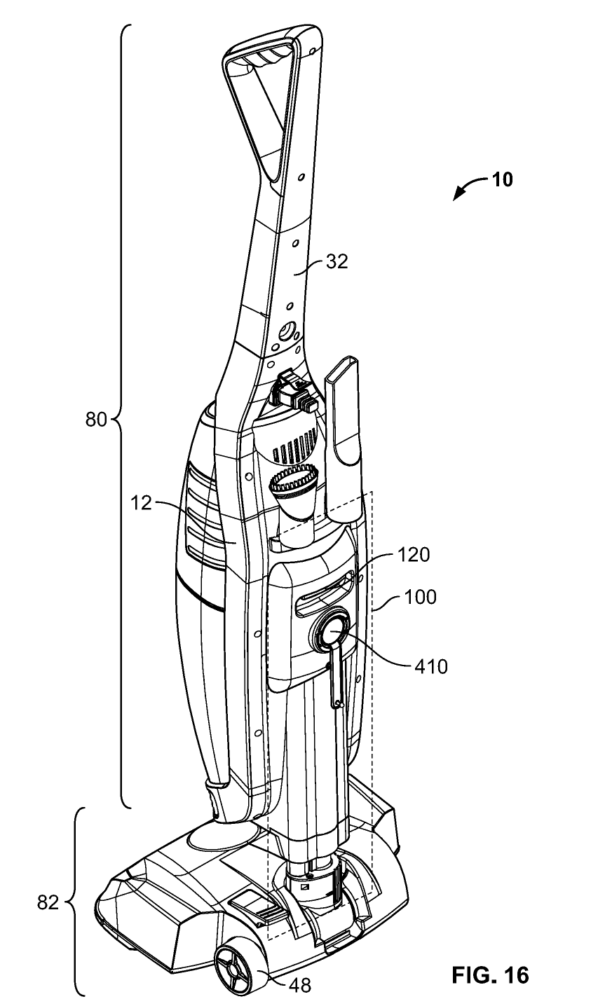

Referring to FIG. 16, an isometric view of the upright vacuum cleaner 10 with an extendable head 82, the upright vacuum cleaner 10 is shown in its lowered position.

The body 80 contains the majority of the upright vacuum cleaner 10 components, which are substantially hidden by the housing 12.

The extension mechanism 100 permits extension of the body 80 up and away from the head 82. The movement is linear, in an up/down direction when the upright vacuum cleaner is in a resting position. The extension mechanism 100 is shown as a region, as many of its components are hidden within the housing 12.

The upper section of the body 80 forms a handle 32.

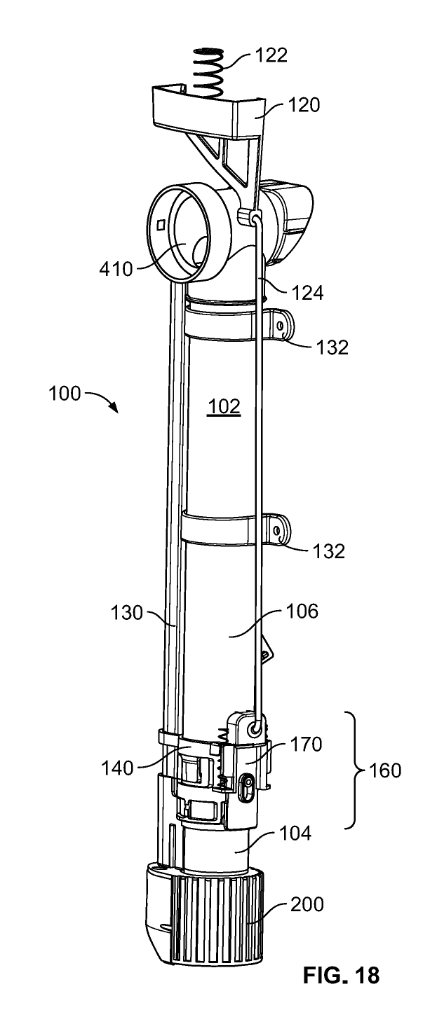

The adjustment handle 120 actuates the extension mechanism 100, allowing the user to engage/disengage the locking mechanism 160 (see FIG. 18) that maintains the height of the body 80.

Also shown is the tool inlet 410 for connection to a hose for use of hand tools. The base 82 includes one or more wheels 48 to aid in motion of the upright vacuum 10.

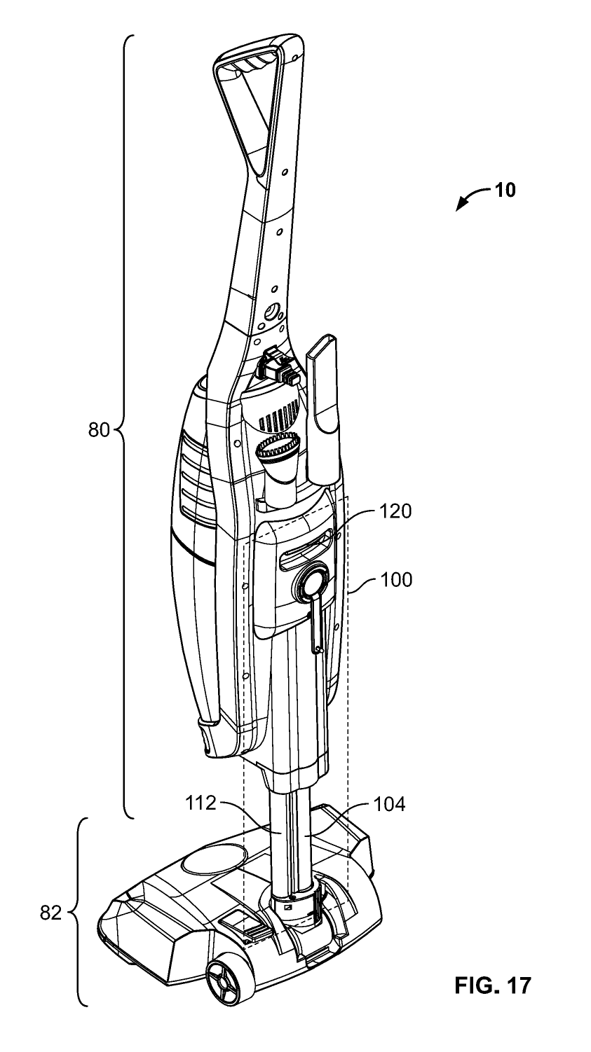

Referring to FIG. 17, an isometric view the upright vacuum cleaner 10 is shown.

The body 80 is shown in a raised position with respect to the head 82.

Portions of the components of the extension mechanism 100 are now visible, with the inner telescoping tube 104 and the adjustable length electrical cable 112 both visible. The inner telescoping tube 104 carries air drawn into the upright vacuum cleaner 10 from the head 82 and into the body 80. The air is channeled internally through a filter, dust and debris collected, and the clean area then exhausted.

Referring to FIG. 18, a view of the extension mechanism 100 from within the upright vacuum cleaner 10 is shown.

Air is carried through the extension mechanism 100 by an adjustable length inlet tube 102 formed from an inner telescoping tube 104 and an outer telescoping tube 106.

The position of the inner telescoping tube 104 is fixed with respect to the head 82 (see FIG. 16), the head 82 is connected to the inner telescoping tube 104 by the power head connection 200.

The position of the outer telescoping tube 106 is fixed with respect to the body 80 (see FIG. 16), the body 80 is connected to the outer telescoping tube 106 by one or more brackets 132.

The position of the inner telescoping tube 104 is adjustable with respect to the outer telescoping tube 106 by actuation of the locking mechanism 160.

To adjust the position of the body 80 (see FIG. 17), the user pulls up on the adjustment handle 120, the movement of which is resisted by the handle resilient member 122. Movement of the adjustment handle 120 pulls up on the connecting rod 124, which in turn moves the latch 170. As explained further below, the latch 170 slides along the collar 140. As the latch 170 slides, it permits a change in length of the adjustable length inlet tube 102, thereby allowing a change in height of the upright vacuum cleaner 10 (see FIG. 17).

The collar 140 is affixed at the base of the outer telescoping tube 106, which in this embodiment is stationary with respect to the body 80 (see FIG. 17) of the upright vacuum cleaner 10 (see FIG. 17).

The power cable conduit 130 guides the adjustable length electrical cable 112 (see FIG. 17) as the adjustable length inlet tube 102 changes in length.

Also shown in FIG. 18 is the tool inlet 410, for use when the upright vacuum cleaner 10 (see FIG. 17) is connected to hand cleaning tools.

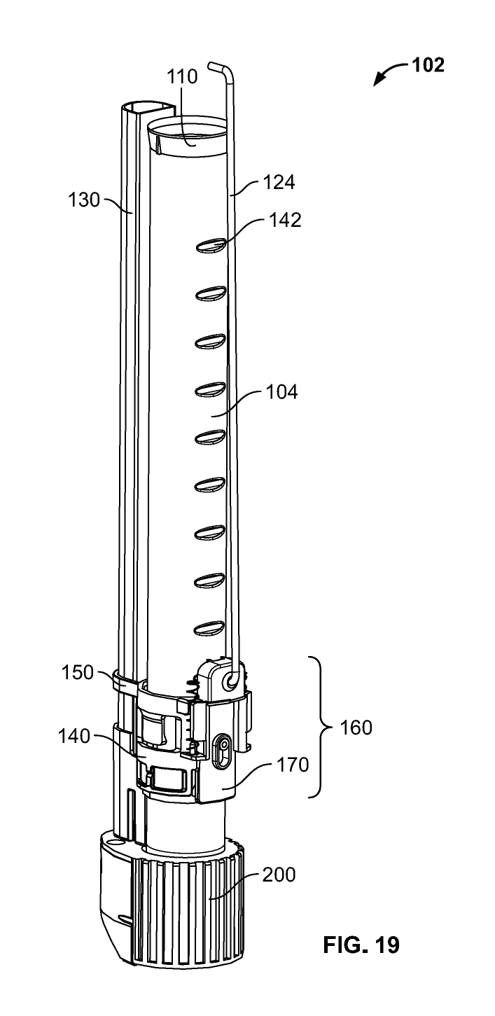

Referring to FIG. 19, the adjustable length inlet tube 102 that interacts locking mechanism 160 is shown. The outer telescoping tube 106 (see FIG. 18) is hidden in this figure, showing the inner telescoping tube 104 in its most retracted position.

The tube gasket 110 allows movement of the inner telescoping tube 104 within the outer telescoping tube 106 (see FIG. 18), while maintaining an air-tight seal.

As explained further below, the notches 142 act to hold the position of the inner telescoping tube 104 chosen by the user.

As discussed above, the collar 140 is affixed to the outer telescoping tube 106 (see FIG. 18), which is hidden in this figure. As the inner telescoping tube 104 moves with respect to the collar 140, the power cable conduit 130 slides through the conduit ring 150, which keeps the power cable conduit 130 in a set position to ensure smooth operation.

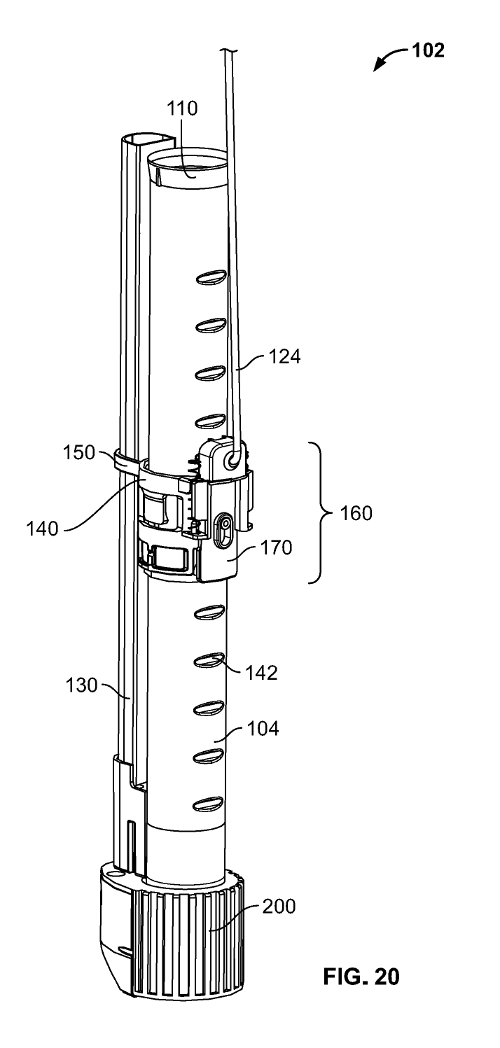

Referring to FIG. 20, the adjustable length inlet tube 102 that interacts with a latching mechanism 160 to hold the upright vacuum cleaner 10 in a chosen position, is shown in its raised or extended position.

The collar 140 has moved upward with respect to the inner telescoping tube 104. The latch 170 then interacts with a higher set of notches 142.

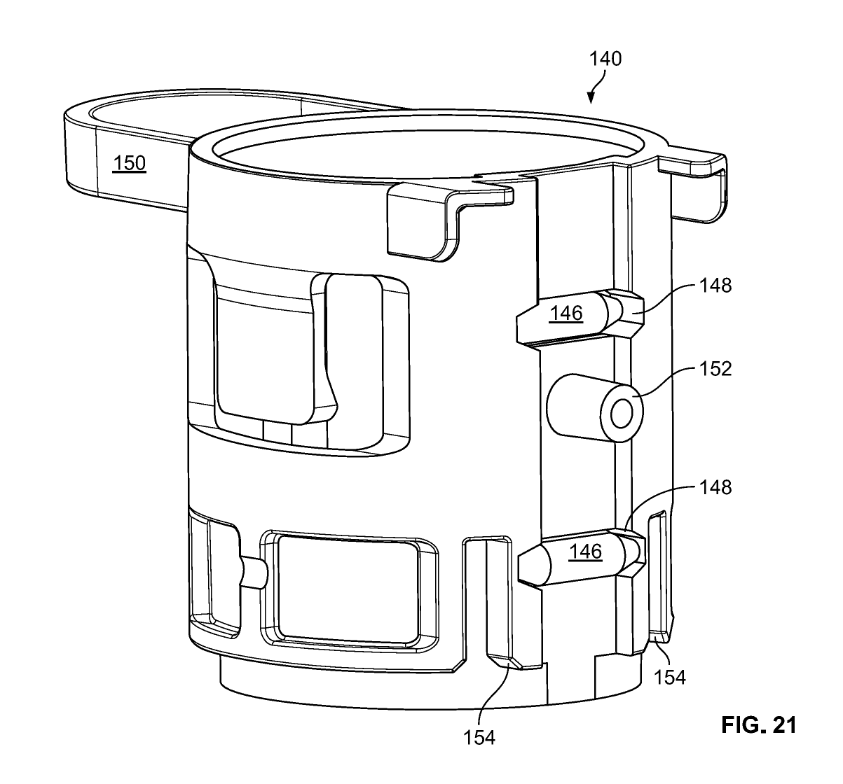

Referring to FIG. 21, the collar 140 that forms the basis for the locking mechanism 160 (see FIG. 20) that holds the adjustable length inlet tube 102 in place is shown.

One or more captive rollers 146 slide within roller channels 148 of the collar 140. When the rollers 146 are within notches 142 (see FIG. 20), the position of the inner telescoping tube 104 (see FIG. 20) is fixed. When the rollers 146 are permitted to slide outward, but within, the roller channels 148, the position of the inner telescoping tube 104 (see FIG. 20) is adjustable.

Also shown in FIG. 21 are features that interact with the latch 170 (see FIG. 20). Specifically, the limit stop protrusion 152, which limits the upward/downward movement of the latch 170 (see FIG. 20), and the locking channels 154, which hold the latch 170 (see FIG. 20) against the collar 140.

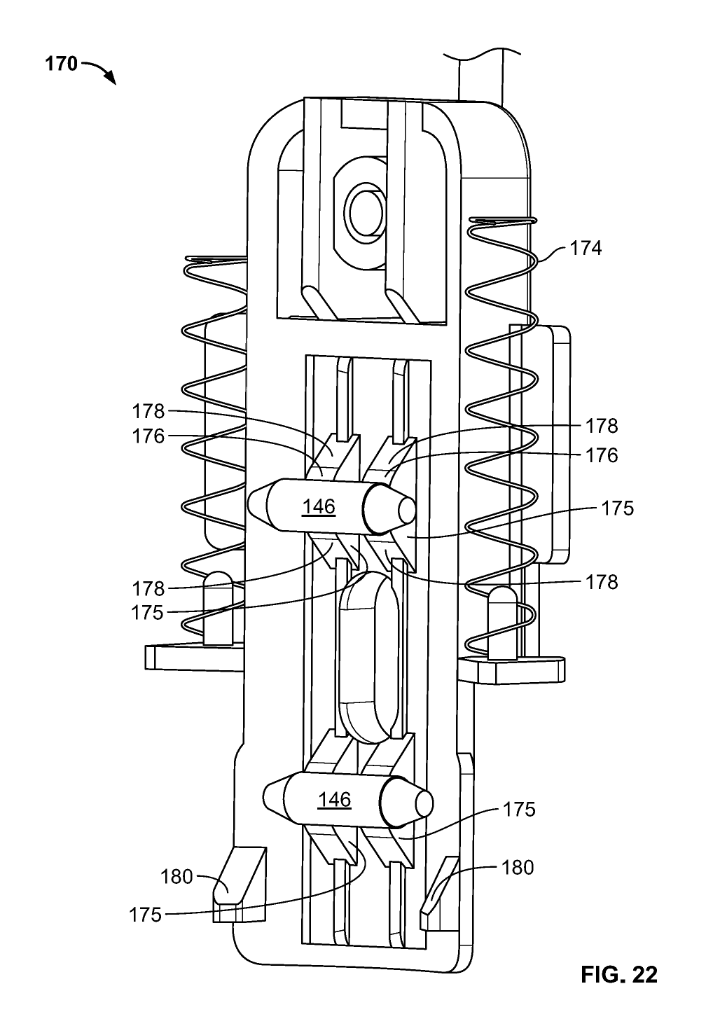

Referring to FIG. 22, the latch 170 that acts to engage and disengage the rollers 146 against the inner telescoping tube 104 (see FIG. 20) is shown.

The vertical position of the latch 170 along the inner telescoping tube 104 (see FIG. 20) affects the position of the roller projections 175 with respect to the rollers 146. When the latch 170 is in a locked position, the roller locking face 176 is against each roller 146, pushing the roller 146 into a notch 142 (see FIG. 19).

To adjust the height of the upright vacuum cleaner 10, the user pulls up on the adjustment handle 120 (see FIG. 17), which in turn moves the connecting rod 124 (see FIG. 20) upward, and moves the latch 170 upward. When the latch 170 moves upward, the roller 146 rides down the roller ramp 178, which permits the roller 146 to leave the notch 142 (see FIG. 20). With the roller 146 no longer placed within a notch 142, the inner telescoping tube 104 (see FIG. 20) is free to move.

The user raises the body 80 (see FIG. 17) to the desired height, and then releases the adjustment handle 120 (see FIG. 17). The handle resilient member 122 (see FIG. 18) creates a downward force on the connecting rod 124 (see FIG. 18), the force carried to the latch 170. The rollers 146 are in contact with the roller ramps 178, which try to push the roller 146 away from the latch 170, and thus into a notch 142 (see FIG. 20).

When the body 80 (see FIG. 17) is in a vertical position where the rollers 146 line up with notches 142 (see FIG. 20), the rollers 146 snap into position, and the latch 170 is again in its lowered position.

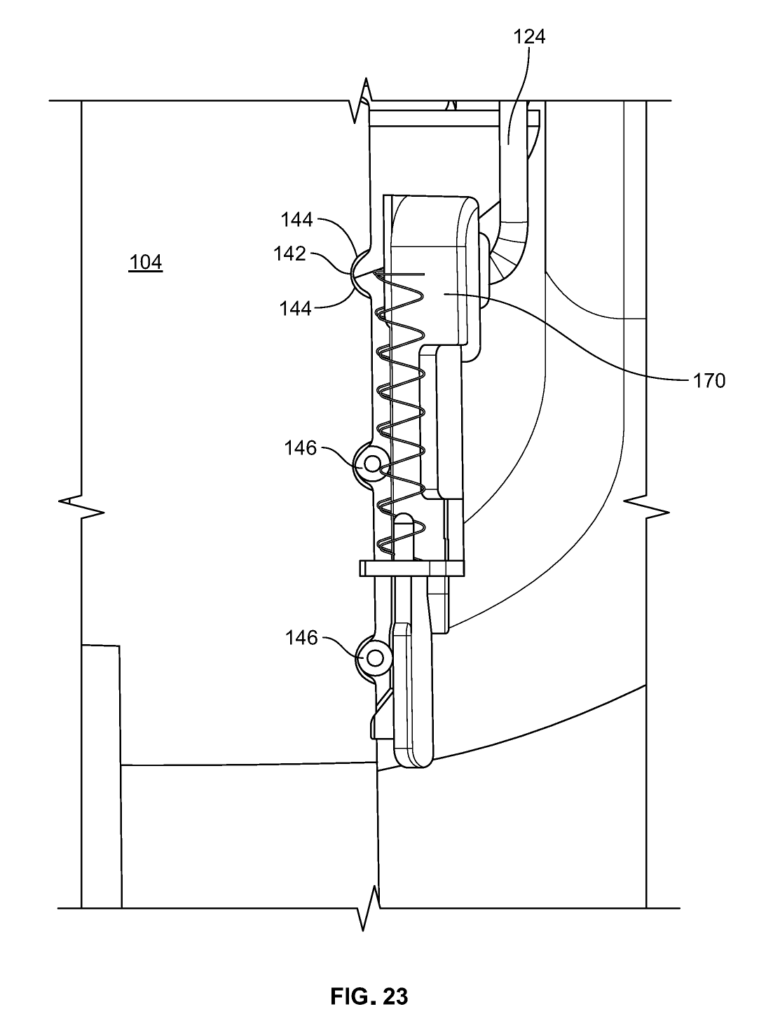

Referring to FIG. 23, a view from the what would be the rear of the upright vacuum 10 is shown, with the latch 170 interacting with the notches 142 of the inner telescoping tube 104, the collar 140 (see FIG. 20) hidden from view.

The notches 142 include sloped notch walls 144 to help the captive rollers 146 lock into place. The latch 170 is shown in the locked position, with the captive rollers 146 within notches 142. In this position, the downward load of the body 80 (see FIG. 16) is passed to the outer telescoping tube 106 (see FIG. 18), to the collar 140 (see FIG. 18), to the captive rollers 146, to the inner telescoping tube 104, and finally to the head 82 (see FIG. 16) through the power head connection 200 (see FIG. 18).

Equivalent elements can be substituted for the ones set forth above such that they perform in substantially the same manner in substantially the same way for achieving substantially the same results.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An upright vacuum cleaner able to fit in small spaces, the upright vacuum cleaner comprising:
a telescoping vacuum head;
a vacuum body that includes a reservoir and motor;
the vacuum body located above the telescoping vacuum head during use of the upright vacuum;
the telescoping vacuum head able to extend away from the vacuum body;
thereby permitting the telescoping vacuum head to slide under furniture and other home obstacles.

2. The upright vacuum cleaner of claim 1, further comprising:
an extension mechanism;
the extension mechanism connecting the telescoping vacuum head and vacuum body;
the extension mechanism able to vary in length;
the extension mechanism able to lock at one or more indexed positions;
whereby the extension mechanism is adapted to be actuated by a user, allowing the user to adjust the distance between the telescoping vacuum head and vacuum body.

3. The upright vacuum cleaner of claim 2, wherein the extension mechanism further comprises:
an adjustment handle;
a connecting rod; and
a latch;
the adjustment handle adapted to be actuated by the user, with movement of the adjustment handle causes motion of the connecting rod, which in turn causes movement of the latch.

4. The upright vacuum cleaner of claim 3, further comprising:
a collar with one or more roller channels;
the collar within the extension mechanism;
one or more captive rollers placed within the one or more roller channels;
the position of the latch affecting the position of the one or more captive rollers within the one or more roller channels;
a raised latch position allowing the one or more captive rollers to disengage, permitting the extension mechanism to vary in length;
a lowered latch position causing the one or more rollers to engage, thereby preventing the extension mechanism from varying in length.

5. The upright vacuum cleaner of claim 4, wherein the extension mechanism further comprises:
an outer telescoping tube;
an inner telescoping tube that slides within the outer telescoping tube;
the inner telescoping tube includes a plurality of notches;
the plurality of notches interacting with the one or more captive rollers to permit engagement and disengagement of the extension mechanism, and thereby permit adjustment of the relative positions of the telescoping vacuum head and the vacuum body.

6. The upright vacuum cleaner of claim 1, wherein the extension mechanism further comprises:
an adjustment handle;
a connecting rod; and
a latch;
the adjustment handle adapted to be actuated by the user, with movement of the adjustment handle causing motion of the connecting rod, which in turn causes movement of the latch;
movement of the latch changing the position of one or more captive rollers;
an outer telescoping tube;
an inner telescoping tube that slides within the outer telescoping tube;
the inner telescoping tube include a plurality of notches;
the notches interacting with the one or more captive rollers to permit engagement and disengagement of the extension mechanism, and thereby permit adjustment of the relative positions of the telescoping vacuum head and the vacuum body.

7. An upright vacuum with a variable height, the upright vacuum comprising:
a vacuum body;
the vacuum body including an extension mechanism;
a vacuum head;
the vacuum head connected to the vacuum body by the extension mechanism;
the vacuum body positioned vertically above the vacuum head when the upright vacuum is at rest;
the extension mechanism able to change in length, thereby changing the vertical position of the vacuum body with respect to the vacuum head.

8. The upright vacuum of claim 7, wherein:
the extension mechanism locks at one or more indexed positions;
whereby the extension mechanism is adapted to be actuated by a user, allowing the user to adjust the distance between the telescoping vacuum head and vacuum body.

9. The upright vacuum of claim 8, wherein the extension mechanism further comprises:
an adjustment handle;
a connecting rod; and
a latch;
the adjustment handle adapted to be actuated by the user, with movement of the adjustment handle causing motion of the connecting rod, which in turn causes movement of the latch and permits adjustment of the vertical position of the vacuum body.

10. The upright vacuum of claim 9, further comprising:
a collar with one or more roller channels;
the collar within the extension mechanism;
one or more captive rollers placed within the one or more roller channels;
the position of the latch affecting the position of the one or more captive rollers within the one or more roller channels;
a raised latch position allowing the one or more captive rollers to disengage, permitting the extension mechanism to vary in length;
a lowered latch position causing the one or more rollers to engage, thereby preventing the extension mechanism from varying in length.

11. The upright vacuum of claim 10, wherein the extension mechanism further comprises:
an outer telescoping tube;
an inner telescoping tube that slides within the outer telescoping tube;
the inner telescoping tube include a plurality of notches;
the notches interacting with the one or more captive rollers to permit engagement and disengagement of the extension mechanism, and thereby permit adjustment of the relative positions of the telescoping vacuum head and the vacuum body.

12. The upright vacuum of claim 8, wherein the extension mechanism further comprises:
an adjustment handle;
a connecting rod; and
a latch;
the adjustment handle adapted to be actuated by the user, with movement of the adjustment handle causing motion of the connecting rod, which in turn causes movement of the latch;
movement of the latch changing the position of one or more captive rollers;
an outer telescoping tube;
an inner telescoping tube that slides within the outer telescoping tube;
the inner telescoping tube include a plurality of notches;
the notches interacting with the one or more captive rollers to permit engagement and disengagement of the extension mechanism, and thereby permit alteration of the relative positions of the telescoping vacuum head and the vacuum body.

13. An upright vacuum cleaner that can clean in small spaces, the upright vacuum cleaner comprising:
a head;
a body;
the head and body connected by an adjustable length inlet tube;
the adjustable length inlet tube supporting the body in a position above the head;
whereby the body of the upright vacuum cleaner moves toward and away the head.

14. The upright vacuum cleaner of claim 13, further comprising:
an extension mechanism;
the extension mechanism connecting the telescoping vacuum head and vacuum body;
the extension mechanism able to vary in length;
the extension mechanism able to lock at one or more indexed positions;
whereby the extension mechanism is adapted to be actuated by a user, allowing the user to adjust the distance between the telescoping vacuum head and vacuum body.

15. The upright vacuum cleaner of claim 14, wherein the extension mechanism further comprises:
an adjustment handle;
a connecting rod; and
a latch;
the adjustment handle adapted to be actuated by the user, with movement of the adjustment handle causing motion of the connecting rod, which in turn causes movement of the latch.

16. The upright vacuum cleaner of claim 15, further comprising:
a collar with one or more roller channels;
the collar within the extension mechanism;
one or more captive rollers placed within the one or more roller channels;
the position of the latch affecting the position of the one or more captive rollers within the one or more roller channels;
a raised latch position allowing the one or more captive rollers to disengage, permitting the extension mechanism to vary in length;
a lowered latch position causing the one or more rollers to engage, thereby preventing the extension mechanism from varying in length.

17. The upright vacuum cleaner of claim 16, wherein the extension mechanism further comprises:
an outer telescoping tube;
an inner telescoping tube that slides within the outer telescoping tube;
the inner telescoping tube include a plurality of notches;
the notches interacting with the one or more captive rollers to permit engagement and disengagement of the extension mechanism, and thereby permit alteration of the relative positions of the telescoping vacuum head and the vacuum body.

18. The upright vacuum cleaner of claim 13, wherein the extension mechanism further comprises:
an adjustment handle;
a connecting rod; and
a latch;
the adjustment handle adapted to be actuated by the user, with movement of the adjustment handle causing motion of the connecting rod, which in turn causes movement of the latch;
movement of the latch changing the position of one or more captive rollers;
an outer telescoping tube;
an inner telescoping tube that slides within the outer telescoping tube;
the inner telescoping tube include a plurality of notches;
the notches interacting with the one or more captive rollers to permit engagement and disengagement of the extension mechanism, and thereby permit alteration of the relative positions of the telescoping vacuum head and the vacuum body.
